(19) United States
(12) Patent Application Publication
(10) Pub. No.: US 2015/0158518 A1
(43) Pub. Date: Jun. 11, 2015

(54) Roll Frame Handtruck

(71) Applicant: Shiliang Zhao, Orlando, FL (US)

(72) Inventor: Shiliang Zhao, Orlando, FL (US)

(21) Appl. No.: 14/098,943

(22) Filed: Dec. 6, 2013

(51) Int. Cl. B62B 5/00; B62B 5/02

(52) U.S. Cl. CPC B62B 5/0083; B62B 5/02

(57) ABSTRACT

A Handtruck roll frame (10) comprising: a Roll frame (11,) including 2 wheel shafts (12) which are installed the 2 wheels (13 and 14), the Roll Frame on each side of the handtruck, so 2 Roll Frame are installed on the hand truck and a load is supported by 4 wheels instead of 2 wheels. The Roll Frames can rollover on the main axes.

### BACKGROUND OF THE INVENTION

This invention relates generally to a handtruck or dolly to move in less resistence.

### BRIEF SUMMARY OF THE INVENTION

### RollFrame Handtruck

A load which is on 2 wheels vs 4 wheels, 4 wheels roll frame structure will be less 50% ground pressure than 2 wheels in roughly. That roll fame can rollover or sway are working together with less 50% ground pressure to make the load easy to pull or push. when one wheel is baffled by block, this wheel is easy to rise up in ¼ of the load weight in roughly to cross over the block.

### BRIEF DESCRIPTION OF THE SEVERAL VIEWS OF THE DRAWINGS

Preferred features of the present invention will now be described with particular reference to the accompanying drawings. However, it is to be understood that the features illustrated in and described with reference to the drawings are not to be construed as limiting on the scope of the invention. In the drawings:

FIG. 1 is a right side view of a roll frame of the invention;

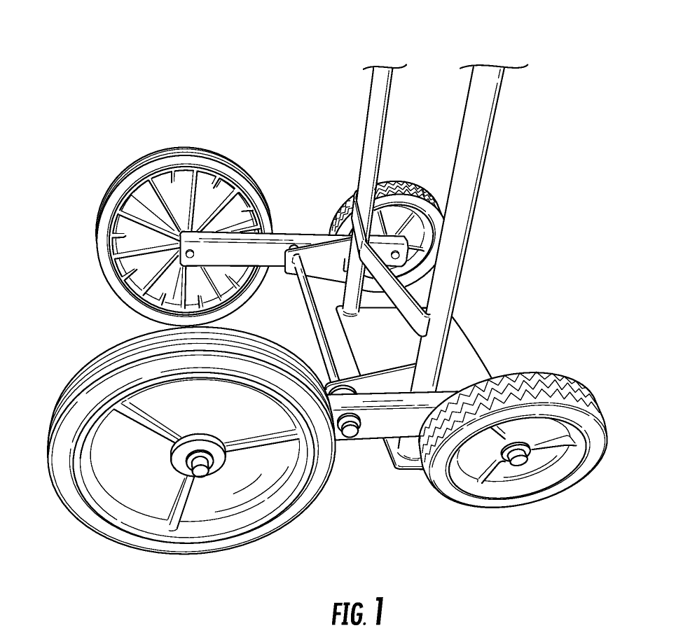

FIG. 2 is a front side view of a roll frame of the invention;

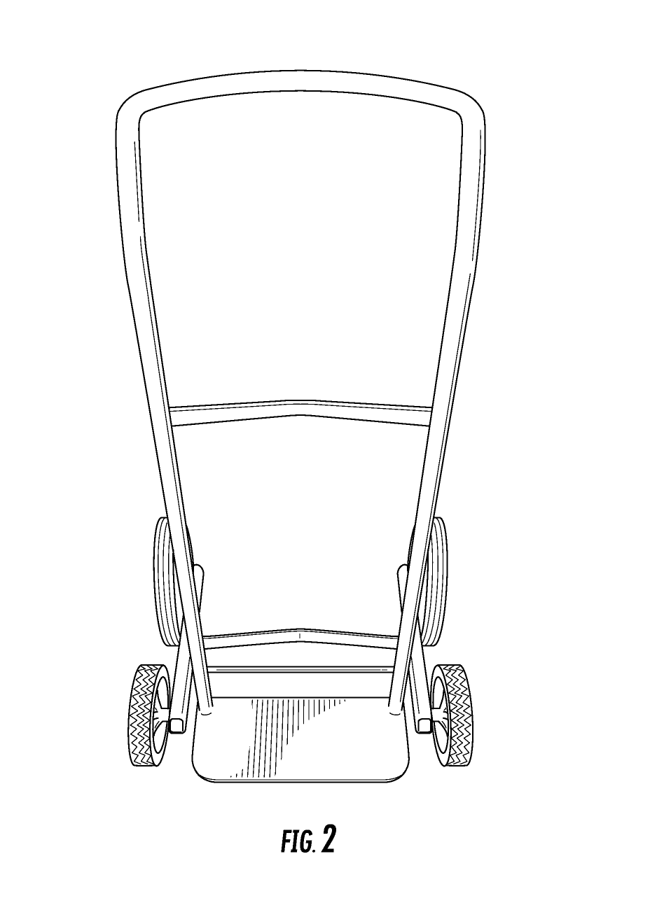

FIG. 3 is a left side view of a roll frame of the invention;

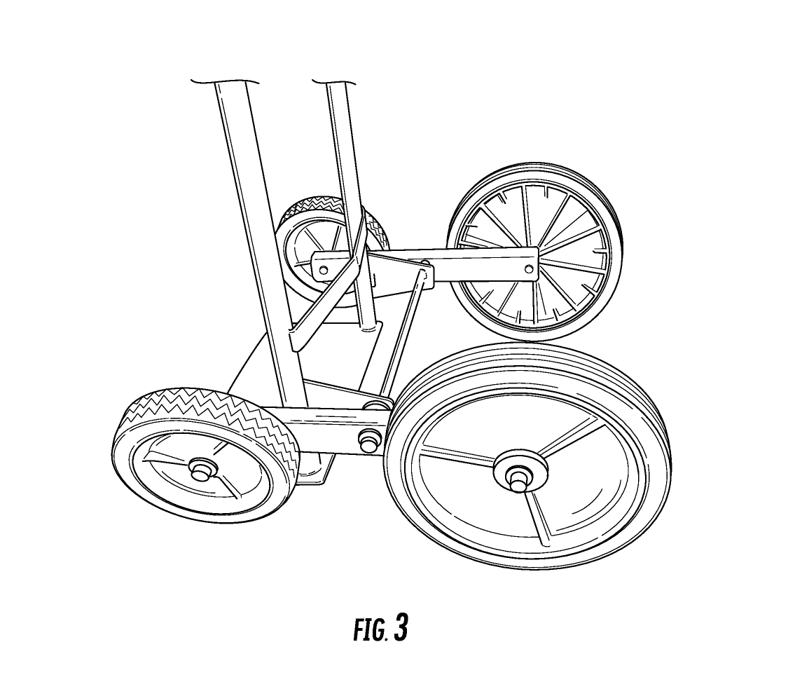

FIG. 4 is a roll frame sway on block.

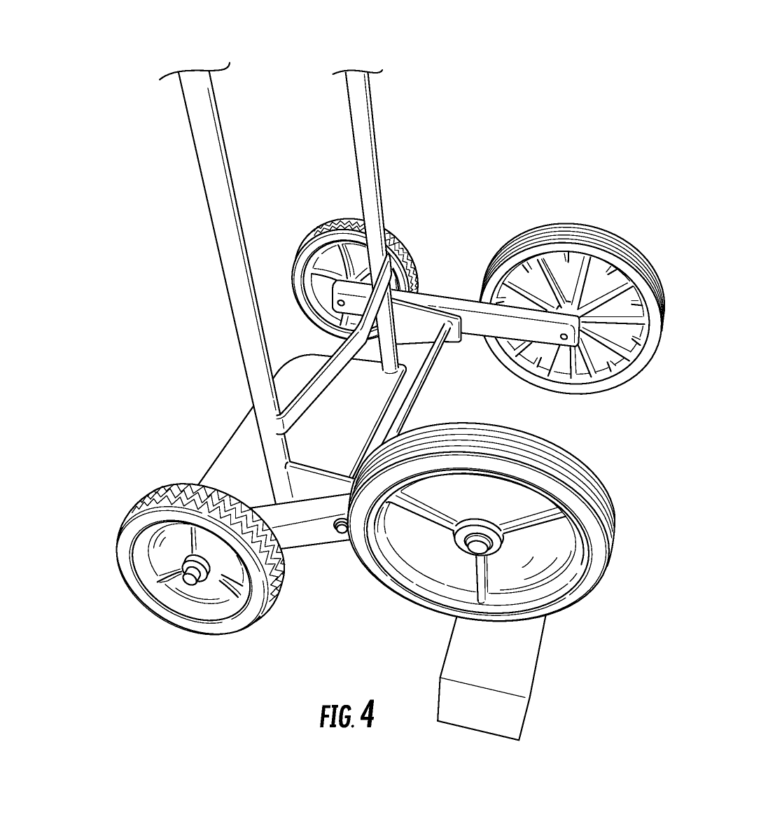

What is claimed is:

1. A roll frame comprising: a metal roll frame including 2 shafts on both sides of the roll frame to install 2 wheels, the roll frame generally installing on the handtruck shaft by the central position hole and having a front wheel (big diameter) and a rear wheel (small diameter); the handtruck shafts are mounted to the central of the roll frame and a load generally lying in the handtruck frame; each roll frame having a corresponding the wheels resistence to sway or rollover on handtruck axis.

2. A roll frame according to claim 1, wherein said a roll frame has no left side and right side in same structure according to the central holes or hole.

3. A roll frame according to claim 1, wherein said a roll frame has left side and right side in symmetrical structure according to the central holes or hole.

4. A roll frame according to claim 1, wherein said a roll frame has same diameter of 2 wheels.

5. A roll frame according to claim 1, wherein said a roll frame has different diameter of 2 wheels.

6. A roll frame according to claim 4, wherein said a wheel diameter size is corresponding the roll frame size and stair size.

7. A roll frame according to claim 5, wherein said a wheel diameter size is corresponding the roll frame size and stair size.

8. A roll frame according to claim 4, 5, wherein said a handtruck which is installed said roll frame can climb stair by rollover or sway.

9. A roll frame according to claim 8, wherein said a handtruck which is installed said roll frame can climb stair in less pull power according to corresponding design sizes of roll frame and wheels.

10. A roll frame according to claim 9, wherein said a handtruck which is installed said roll frame can move in less pull power on unsmooth surface.

11. A roll frame according to claim 4, 5, wherein said a handtruck which is installed said roll frame can pull up on wall which is from 0 degree to 90 degree coming from about 0 degree surface.
